(19) United States
(12) Patent Application Publication
(10) Pub. No.: US 2024/0201111 A1
(43) Pub. Date: Jun. 20, 2024

(54) SPECIMEN HOLDERS FOR X-RAY DIFFRACTOMETER

(71) Applicant: Saudi Arabian Oil Company, Dhahran (SA)

(72) Inventors: Matteo Leoni, Dhahran (SA); Husin Sitepu, Dhahran (SA); Robert C. Angustia, Al Khobar (SA)

(21) Appl. No.: 18/082,384

(22) Filed: Dec. 15, 2022

(51) Int. Cl. G01N 23/20025; G01N 23/20016

(52) U.S. Cl. CPC G01N 23/20025; G01N 23/20016; G01N 23/20075

(57) ABSTRACT

Example specimen holders for X-ray diffractometer are disclosed. One example specimen holder includes an angle plate. The angle plate includes a first side and a second side. The first side and the second side are configured to join each other at an angle. The first side is configured to couple to a flange of an X-ray diffractometer, where the X-ray diffractometer includes a goniometer. The second side is configured to position a specimen in a measurement position for the X-ray diffractometer, where a rotation axis of the goniometer passes through a surface of the specimen.

### TECHNICAL FIELD

The present disclosure relates to specimen holders for X-ray diffractometer.

### BACKGROUND

An X-ray powder diffraction machine, for example, an X-ray diffractometer, can be used for phase identification of a specimen, such as a crystalline material that is finely ground, and can provide information on unit cell dimensions of the specimen. The specimen can be placed, with an alignment, in the beam path of the X-ray diffractometer in order to be measured. The rotation axis of the goniometer of the X-ray diffractometer passes through the surface of the specimen in the measurement position.

Many specimen holders for X-ray diffractometer are designed for specimens in powder form or specialized for a certain type of measurement or geometry, for example, film, residual stress measurements, or crystallographic texture measurements. Powder diffraction analysis can also be conducted on certain bulk specimen that is considered as a powder in the measured area, for example, a polycrystalline material or an aggregate of grains. In some cases those samples can be mounted in the available sample holders designed for powders or in those designed for stress/texture measurements.

### SUMMARY

The present disclosure involves specimen holders for X-ray diffractometer. One example specimen holder includes an angle plate. The angle plate includes a first side and a second side. The first side and the second side are configured to join each other at an angle. The first side is configured to couple to a flange of the X-ray diffractometer, where the X-ray diffractometer includes a goniometer. The second side is configured to position a specimen in a measurement position for the X-ray diffractometer, where a rotation axis of the goniometer passes through a surface of the specimen.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates an example of an X-ray diffractometer.

FIG. 2 illustrates an example of a specimen holder for bulk specimens.

FIG. 3 illustrates an example of attaching specimen holder in FIG. 2 to a flange of an X-ray diffractometer.

FIG. 4 illustrates an example of three views of the specimen holder in FIG. 2.

FIG. 5 illustrates an example of adjusting the height of a specimen in the specimen holder in FIG. 2 using moldable wax and a spacer.

FIG. 6 illustrates an example variant of the specimen holder in FIG. 2.

FIG. 7 illustrates an example variant of the specimen holder in FIG. 6.

FIG. 8 illustrates an example of a specimen mount that can be used in conjunction with the specimen holder in FIG. 7.

FIG. 9 illustrates an example variant of the specimen holder in FIG. 7.

FIG. 10 illustrates an example of a specimen mount that can be used in conjunction with the specimen holder in FIG. 9.

FIG. 11 illustrates an example plate that can be used with a specimen holder.

FIG. 12 illustrates an example of positioning a specimen holder on the plate in FIG. 11.

FIG. 13 illustrates an example of a tool that can be used to check for specimen positioning.

FIG. 14 illustrates an example of a movable stage mounted on a specimen holder.

FIG. 15 illustrates an example of a prototype of the movable stage in FIG. 14.

FIG. 16 illustrates an example of a prototype of using the prototype in FIG. 15 to mount a specimen.

FIG. 17 illustrates an example of an assembly with a lead screw that can be used to adjust the height of a specimen holder.

FIG. 18 illustrates an example of a specimen holder that can be used with the lead screw in the assembly in FIG. 17.

FIG. 19 illustrates an example of an assembly of a specimen holder attached to a micrometer positioner.

FIG. 20 illustrates an example of a micrometer positioner that can be used in the assembly in FIG. 19.

FIG. 21 illustrates an example prototype of using a specimen holder to measure the exterior surface of a component for fuel cell.

FIG. 22 illustrates an example prototype of using a specimen holder to measure the surface of a treated calcite disk.

FIG. 23 illustrates an example prototype of using a specimen holder to measure the internal coating on a pipe.

FIG. 24 illustrates an example prototype of using a specimen holder to measure the thermogravimetric analysis residue of a reinforced rubber.

FIG. 25 illustrates an example prototype of using a specimen holder to determine the composition of an aluminum oxide catalyst support.

Like reference numbers and designations in the various drawings indicate like elements.

### DETAILED DESCRIPTION

This specification relates to specimen holders that can allow bulk specimens that are not in powder form to be measured on an X-ray diffractometer. Bulk materials (even of considerable size) can be measured nondestructively using the specimen holder, without the need for any grinding of the bulk materials. The specimen holder can avoid interacting with original equipment manufacturer (OEM) software by not having electric parts in the specimen holder.

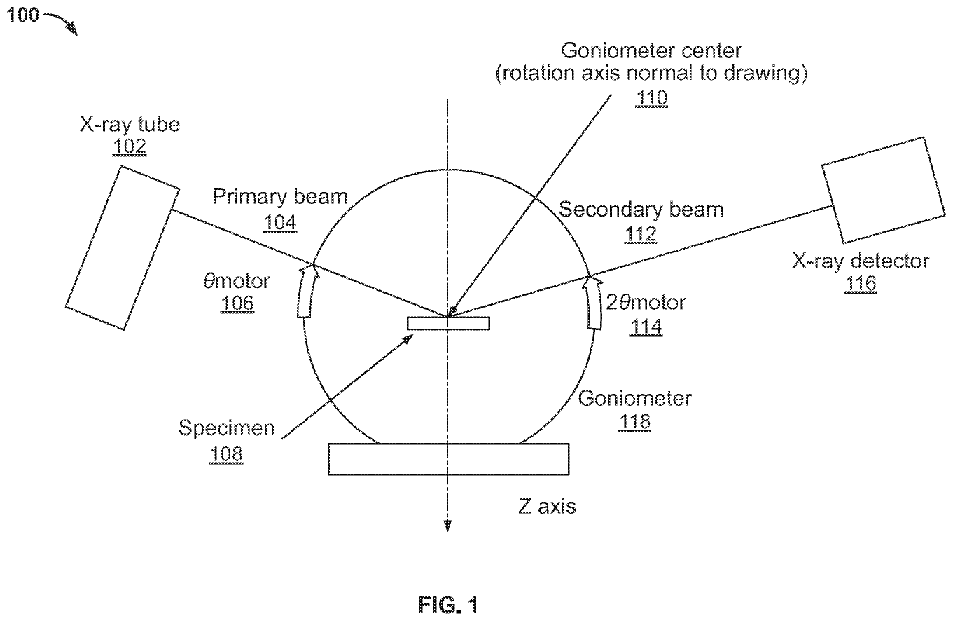

FIG. 1 illustrates a simplified example 100 of an X-ray diffractometer. Primary beam 104 from X-ray tube 102 is radiated on specimen 108 placed on a specimen holder and at the center of goniometer 118. Secondary beam 112 diffracted from specimen 108 is received by X-ray detector 116 and used for analyzing the structure of specimen 108. Goniometer 118 can be used to adjust the relative positions of specimen 108 with respect to X-ray tube 102 and X-ray detector 116.

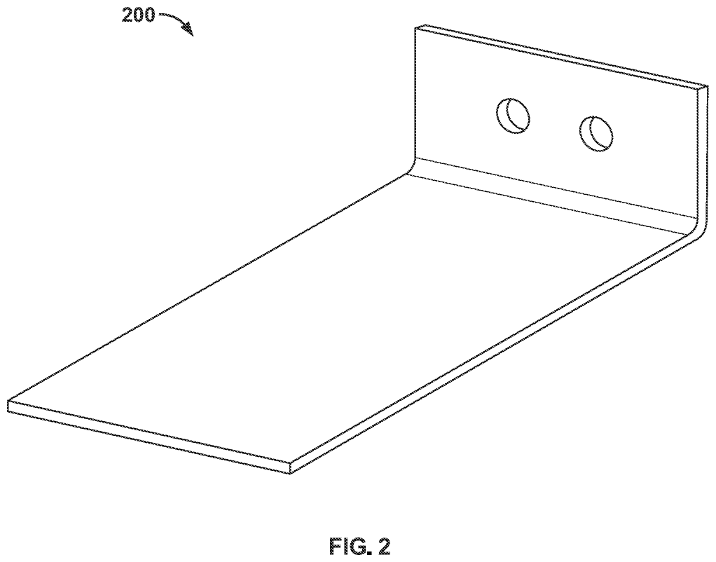

FIG. 2 illustrates an example of a specimen holder 200 for bulk specimens. In some implementations, specimen holder 200 can be an angle plate. One side of specimen holder 200 can be attached to a flange of an X-ray diffractometer, and the other side can be used to hold the specimen. In the example shown in FIG. 2, the two holes on one side of the specimen holder can be used to attach the specimen holder on a flange of an X-ray diffractometer.

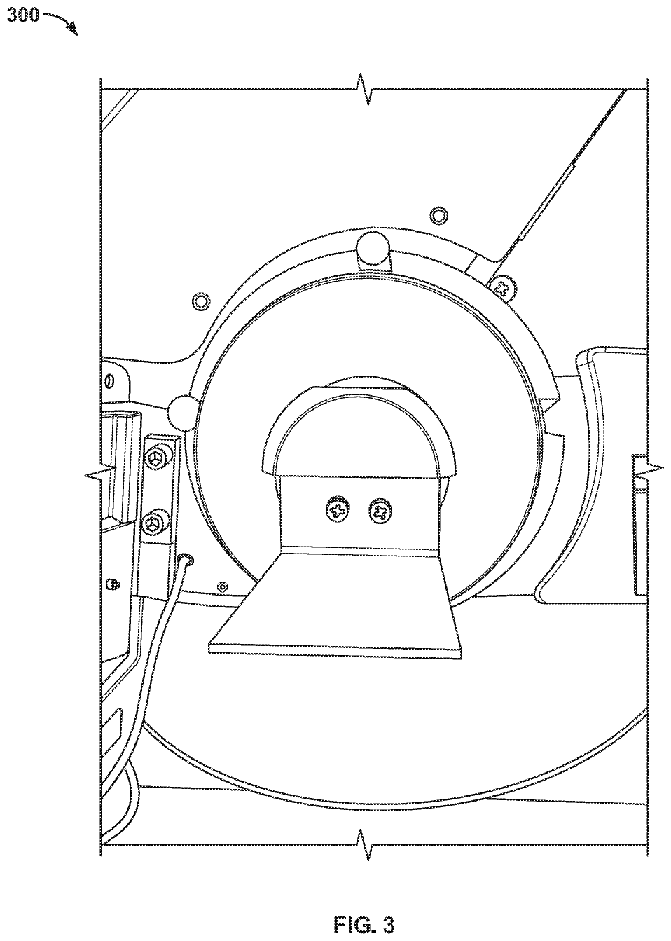

FIG. 3 illustrates an example 300 of attaching specimen holder 200 to a flange of an X-ray diffractometer. As shown in FIG. 3, two screws are used to attach specimen holder 200 to the X-ray diffractometer using the two holes of specimen holder 200.

In some implementations, specimen holder 200 can be adapted for different types of X-ray diffractometers in order to connect to the corresponding goniometer of each X-ray diffractometer, so that the specimen on specimen holder 200 can be positioned in the beam of the diffractometer.

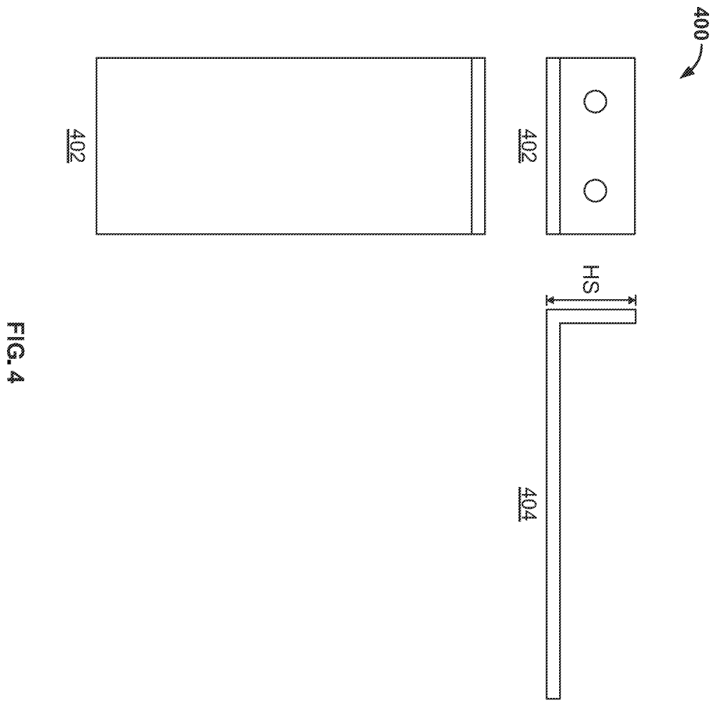

FIG. 4 illustrates an example 400 of three views of specimen holder 200. The three views include side view 402, front view 404, and top view 406 of specimen holder 200.

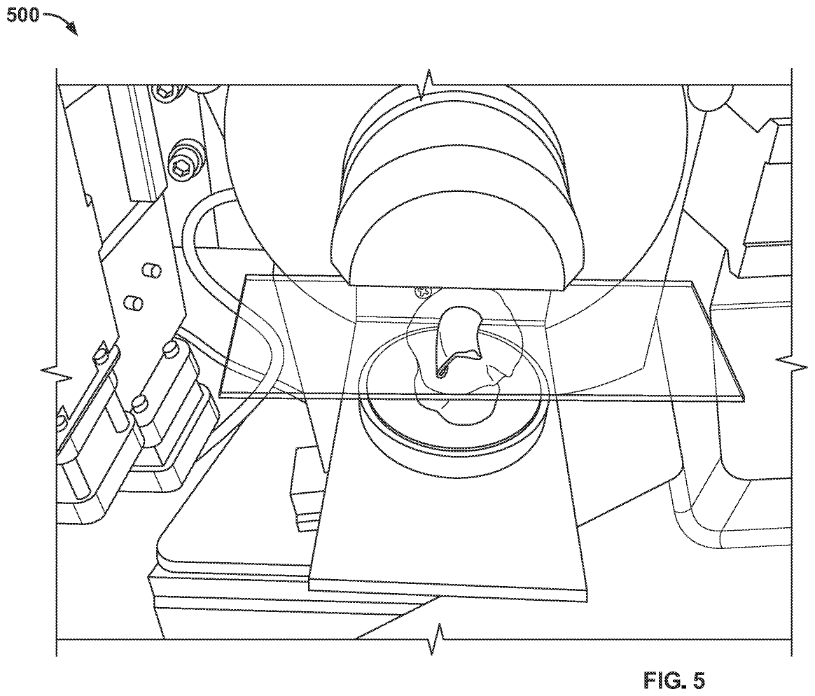

FIG. 5 illustrates an example 500 of adjusting the height of a specimen in specimen holder 200 using moldable wax and a spacer. In some implementations, specimen holder 200 can be a fixed plate. To place the specimen in the beam of the X-ray diffractometer, the specimen on specimen holder 200 can be raised or lowered using moldable wax or another moldable material, and adjusted in height using spacers. As shown in FIG. 5, the specimen is laid on a glass slide and mounted using spacers and wax that are placed on specimen holder 200.

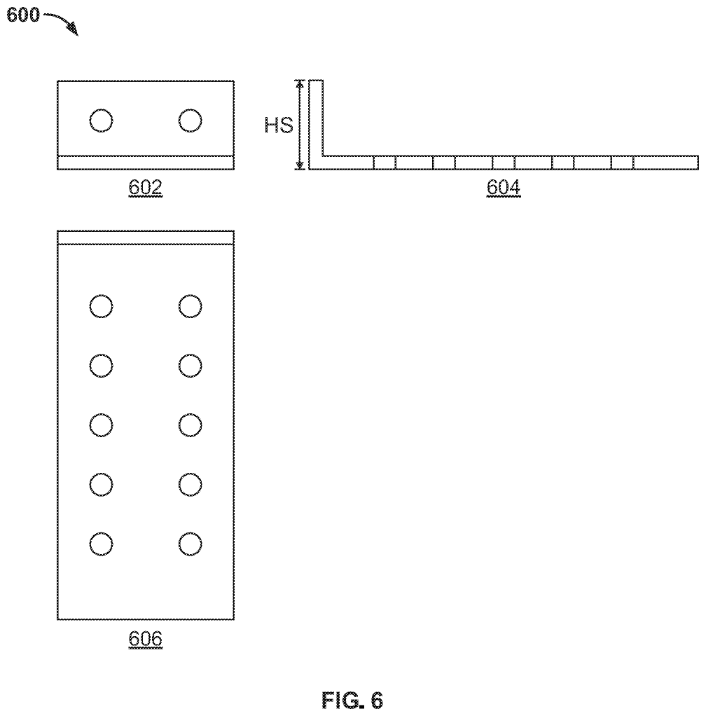

FIG. 6 illustrates an example of a specimen holder 600, which is a variant of specimen holder 200. Specimen holder 600 includes threaded holes on the side of the holder that holds the specimen, in order to allow for the attachment of the specimen or other devices. In some implementations, the specimen can be mounted on a plate with holes corresponding to the threaded holes on specimen holder 600 and can be therefore freely handled, and then the plate with the specimen can be screwed to specimen holder 600. This can help avoid removing specimen holder 600 from the goniometer in order to avoid failure of the screws that have to be fitted to the goniometer itself, for example, the two screws in FIG. 3 used to attach specimen holder 200 to the X-ray diffractometer, as the failure of those screws can lead to the change of the goniometer head. FIG. 6 includes side view 602, front view 604, and top view 606 of specimen holder 600.

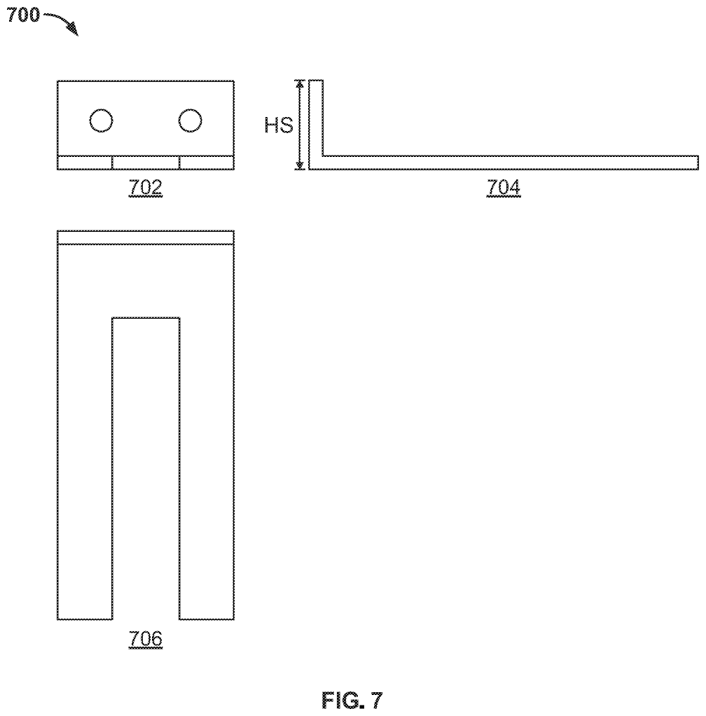

FIG. 7 illustrates an example of a specimen holder 700, which is a variant of specimen holder 600. The threaded holes in specimen holder 600 are also in specimen holder 700, although they are not shown in FIG. 7 for cleanliness of FIG. 7. Specimen holder 700 can be adapted to different specimen shapes and sizes, provided that the maximum height (along the normal of the surface to be measured) is lower than the distance between the side of the holder that holds the specimen and the rotation axis of goniometer 118. FIG. 7 includes side view 702, front view 704, and top view 706 of specimen holder 700.

In some implementations, to simplify the mounting of the specimen in specimen holder 700, a gauge can be created with fixed height that corresponds to the distance between the side of specimen holder 700 that holds the specimen and the goniometer axis. The gauge can be used in conjunction with some specimen mounts. For example, the specimen can be mounted and aligned on a specimen mount and then positioned on the fork-shaped side of specimen holder 700. The gauge can be used to ensure that the height of the sample is correct in the final assembly, as the specimen mount can be automatically aligned with respect to specimen holder 700.

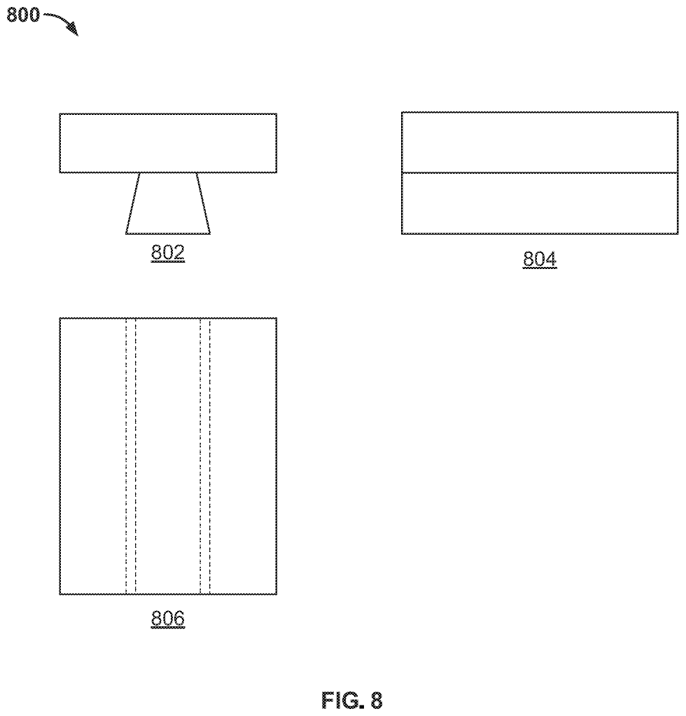

FIG. 8 illustrates an example of a specimen mount 800 that can be used in conjunction with specimen holder 700. Specimen mount 800 can be inserted into the fork-shaped side of specimen holder 700 by sliding it in between the forks of specimen holder 700. FIG. 8 includes side view 802, front view 804, and top view 806 of specimen mount 800.

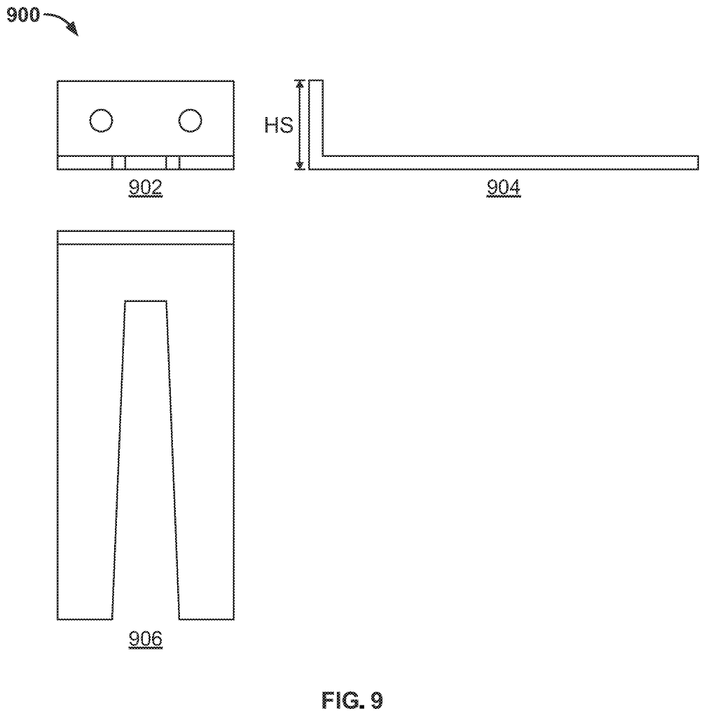

FIG. 9 illustrates an example of a specimen holder 900, which is a variant of specimen holder 700. The threaded holes in specimen holder 600 are also in specimen holder 900, although they are not shown in FIG. 9 for cleanliness of FIG. 9. As shown in FIG. 9, specimen holder 900 has rails tapering on the side that holds the specimen, in order to increase the capacity of locking a specimen mount in position. FIG. 9 includes side view 902, front view 904, and top view 906 of specimen holder 900.

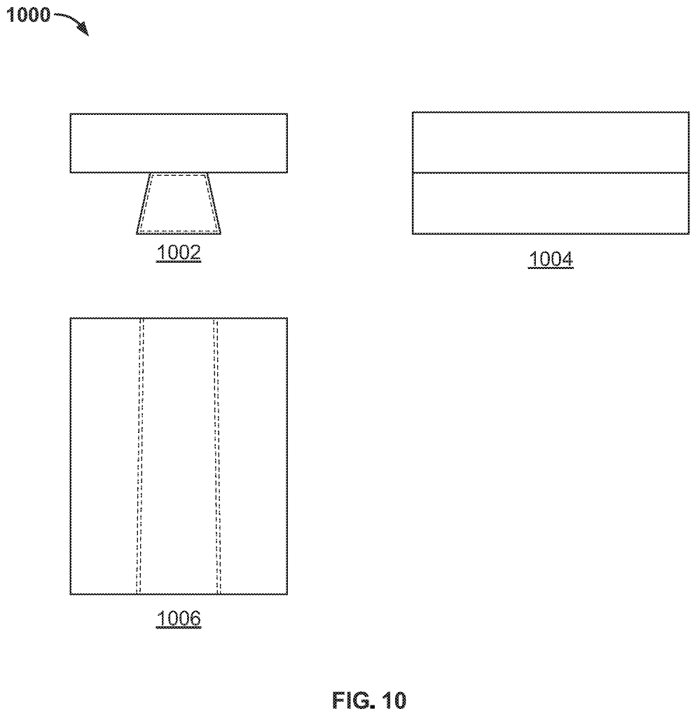

FIG. 10 illustrates an example of a specimen mount 1000 that can be used in conjunction with specimen holder 900. Specimen mount 1000 can be inserted into the fork-shaped side of specimen holder 900 by sliding it in between the forks of specimen holder 900. FIG. 10 includes side view 1002, front view 1004, and top view 1006 of specimen mount 1000. The difference between specimen mount 800 and specimen mount 1000 is a tapering angle in specimen holder 900 and specimen mount 1000 respectively.

In some implementations, the maximum thickness of the specimen held on a specimen holder is determined by the size of the specimen holder and in particular by the HS dimension shown in FIG. 4. The larger the HS, the higher the size of the specimen that is normal to the surface region of the specimen to be measured. Besides creating specimen holders with different lengths to accommodate for different specimen needs and increasing the thickness of specimen holders to increase the rigidity of specimen holders, alternative specimen holders can be implemented to allocate a larger space for the specimen or allow for a finer positioning.

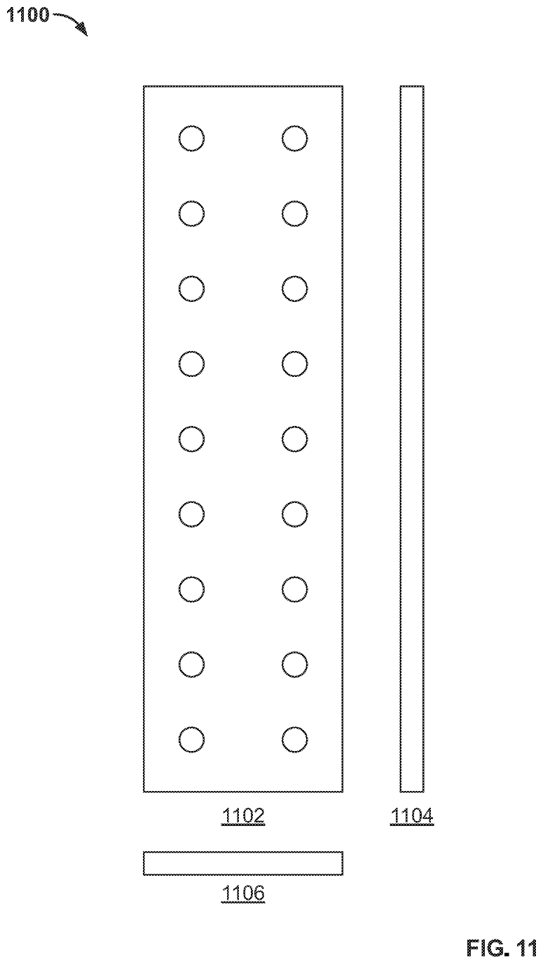

FIG. 11 illustrates an example plate 1100 that can be used with the aforementioned specimen holders to increase the carrying capability of the specimen holders in terms of specimen size. In some implementations, specimen holder 200, 600, 700, or 900 can be positioned and screwed into plate 1100 at different distances with respect to the rotation axis of goniometer 118. FIG. 11 includes side view 1102, front view 1104, and top view 1106 of plate 1100.

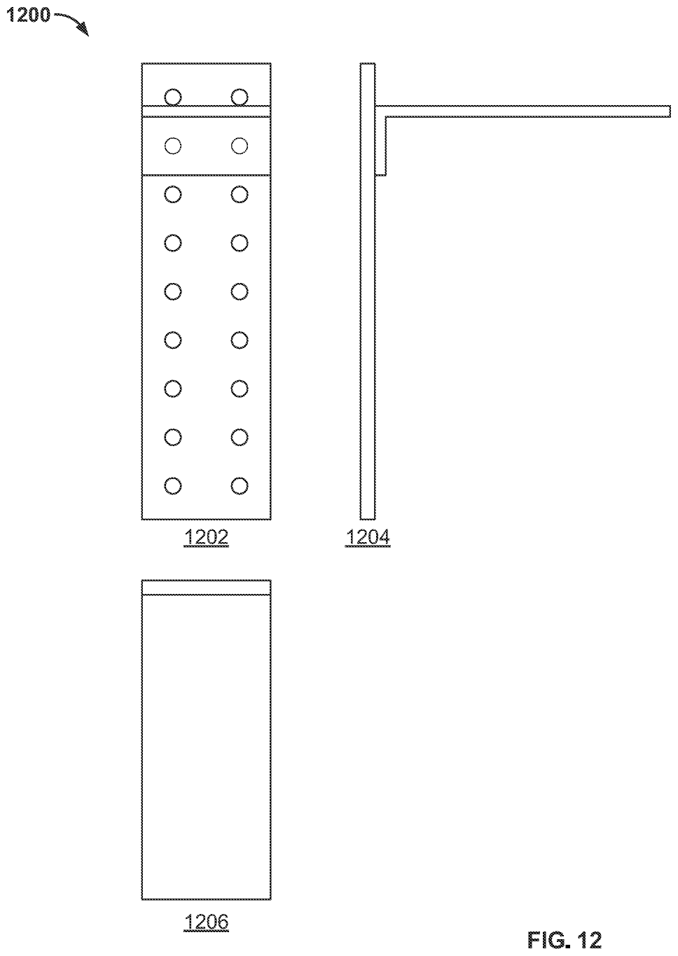

FIG. 12 illustrates an example 1200 of positioning an aforementioned specimen holder on plate 1100. Specimen holder 200, 600, 700, or 900 can also be mounted upside down on plate 1100, as shown in FIG. 12. FIG. 12 includes side view 1202, front view 1204, and top view 1206 of positioning a specimen holder on plate 1100.

In some implementations, a tool to check for the specimen positioning can also be created and adapted to the goniometer head of each type of diffractometer. The tool can give a reference pointing to the center of an area on the specimen illuminated by the beam of the X-ray diffractometer, and being at a height that can accommodate the size of the specimen.

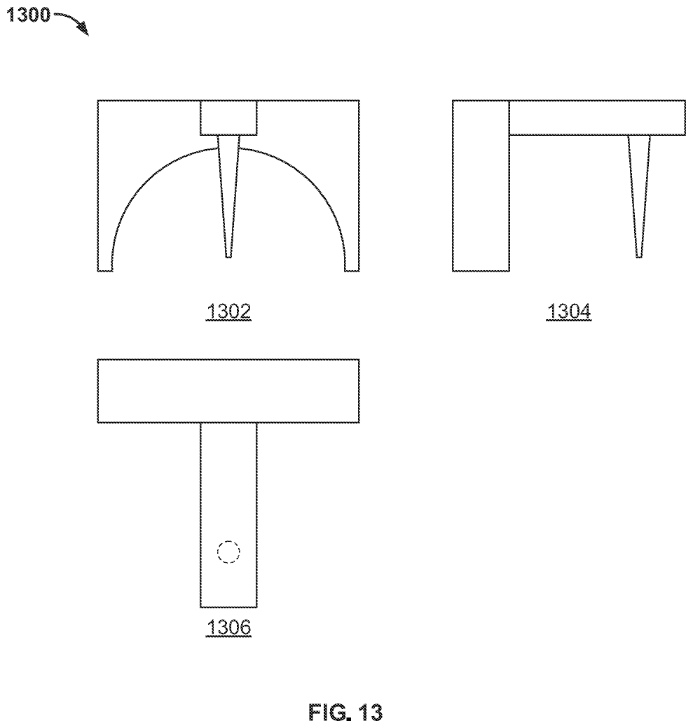

FIG. 13 illustrates an example of a tool 1300 that can be used to check for specimen positioning. FIG. 13 includes side view 1302, front view 1304, and top view 1306 of tool 1300. In some implementations, the tip of tool 1300 can be aligned with the rotation axis of goniometer 118. Tool 1300 can be positioned on the semicircular part of the goniometer head, for example, the semicircular part of the goniometer head shown in FIG. 3, and rotated to ensure that the specimen surface is in contact with the tip and therefore aligned with the rotation axis of goniometer 118.

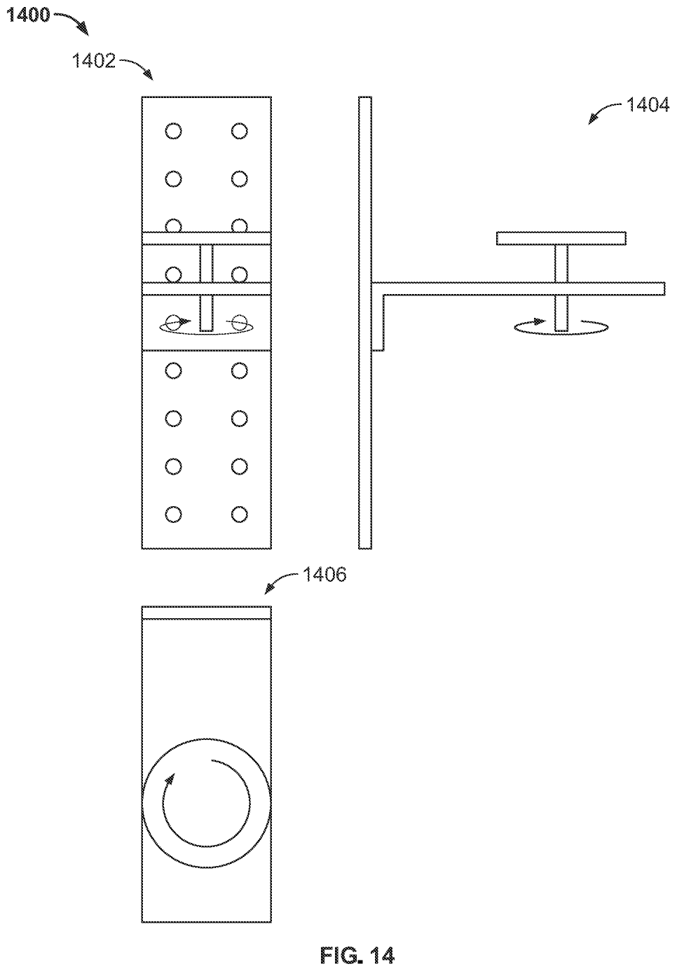

FIG. 14 illustrates an example movable stage 1400 mounted on a specimen holder, for example, one of specimen holders 200, 600, 700, and 900, that is positioned on plate 1100. FIG. 14 includes side view 1402, front view 1404, and top view 1406 of the assembly of movable stage 1400 mounted on a specimen holder that is positioned on plate 1100. In some implementations, moveable stage 1400 can be used to change the height of a specimen placed on moveable stage 1400 through rotation of moveable stage 1400. Moveable stage 1400 can be screwed on the specimen holder through a threaded hold on the specimen holder.

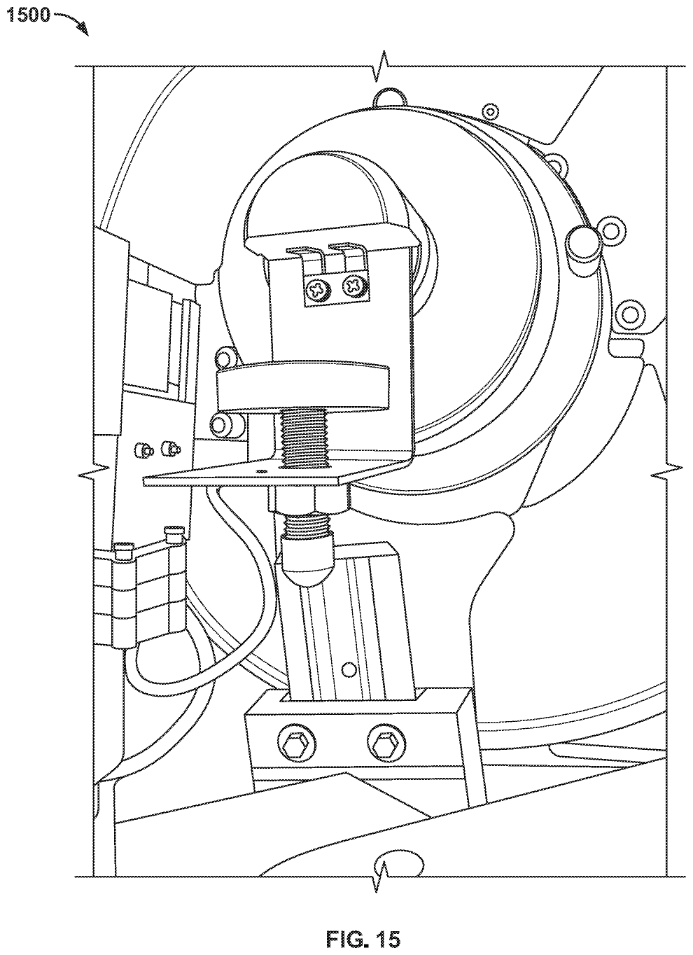

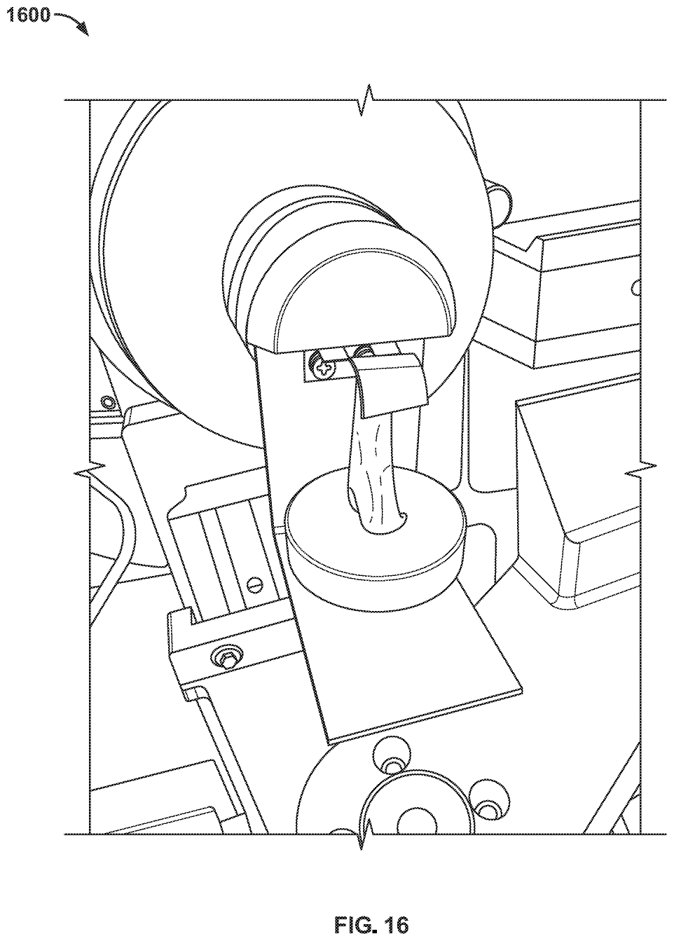

FIG. 15 illustrates an example prototype 1500 of movable stage 1400 mounted on a specimen holder through a threaded hole on the specimen holder. FIG. 16 illustrates an example prototype 1600 of using prototype 1500 to mount a specimen.

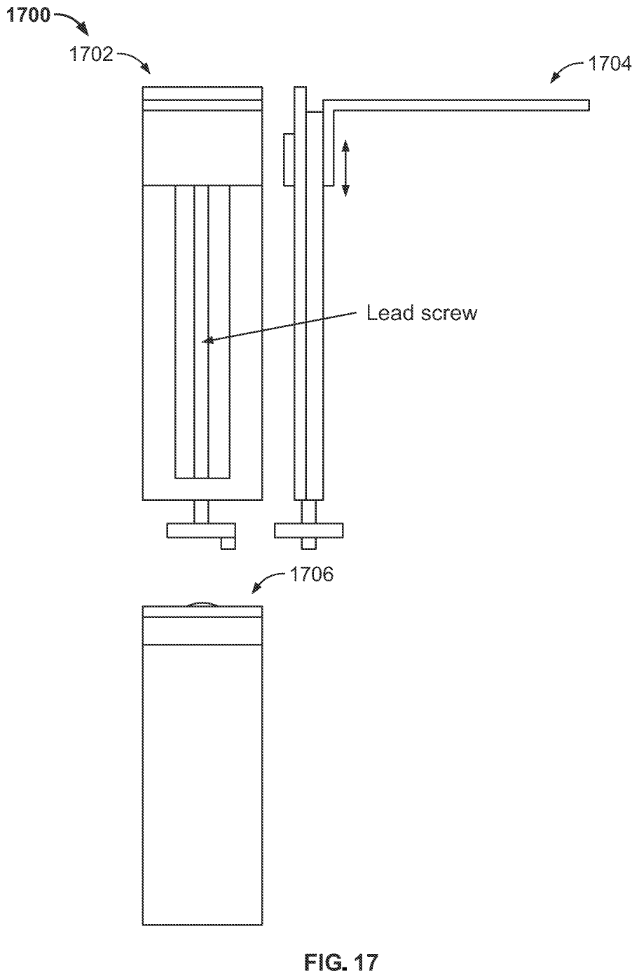

FIG. 17 illustrates an example of an assembly 1700 with a lead screw that can be used to adjust the height of a specimen holder. Assembly 1700 can be attached to a goniometer head using holes similar to those shown in 1102 of FIG. 11. FIG. 17 includes side view 1702, front view 1704, and top view 1706 of assembly 1700.

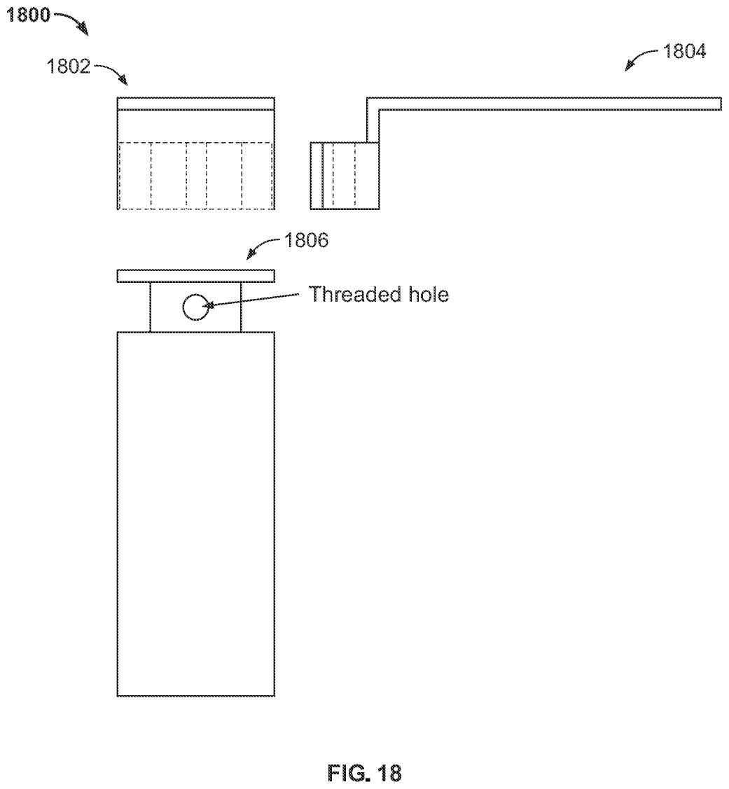

FIG. 18 illustrates an example of a specimen holder 1800 that can be used with the lead screw in assembly 1700. In some implementations, a threaded hole in specimen holder 1800 can be used to mount the lead screw in assembly 1700 so that the height of specimen holder 1800 can be adjusted by the lead screw. The horizontal plate of specimen holder 1800 that holds the specimen is higher than the threaded hole so that the horizontal plate will not hit the goniometer head even when the lead screw moves to its upper limit. FIG. 18 includes side view 1802, front view 1804, and top view 1806 of specimen holder 1800.

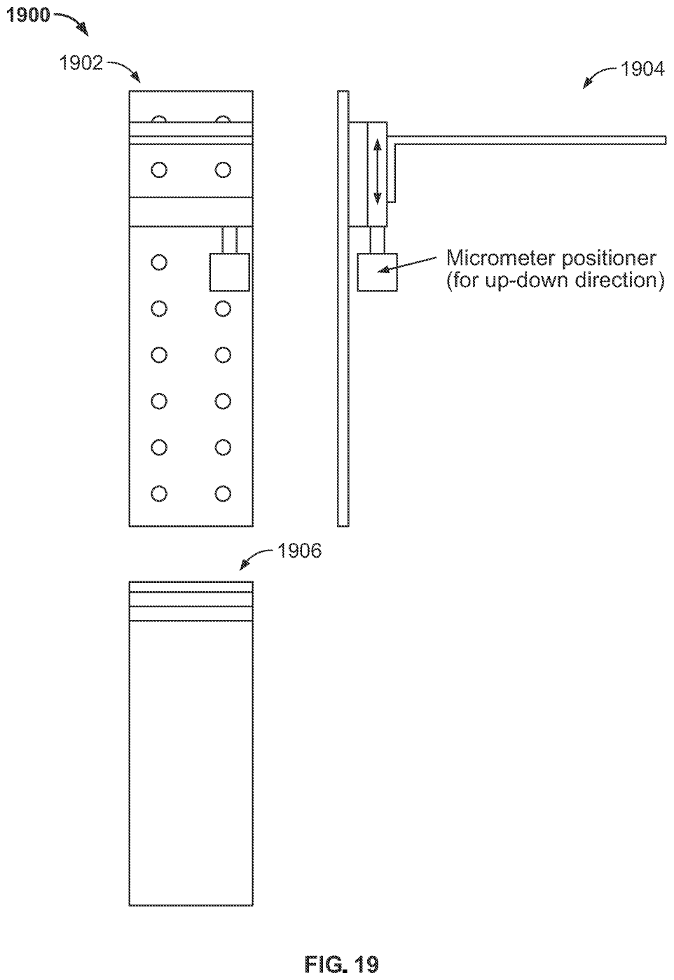

FIG. 19 illustrates an example of an assembly 1900 of a specimen holder attached to a micrometer positioner to allow for fine movement of the specimen holder. The specimen holder can be one of specimen holders 200, 600, 700, and 900. In some implementations, the micrometer positioner can be attached to plate 1100. A motor can be installed on the micrometer positioner, equipped with a speed reducing gear to increase the accuracy of the positioning. The motor can be driven through a simple controller that includes up and down buttons to rotate clockwise or counterclockwise. The manual handle for the micrometer positioner could still be present for coarse positioning or to drive the system in case of motor failure. Additionally, assembly 1700 with a lead screw can be used in place of the mounting plate in FIG. 19. FIG. 19 includes side view 1902, front view 1904, and top view 1906 of assembly 1900.

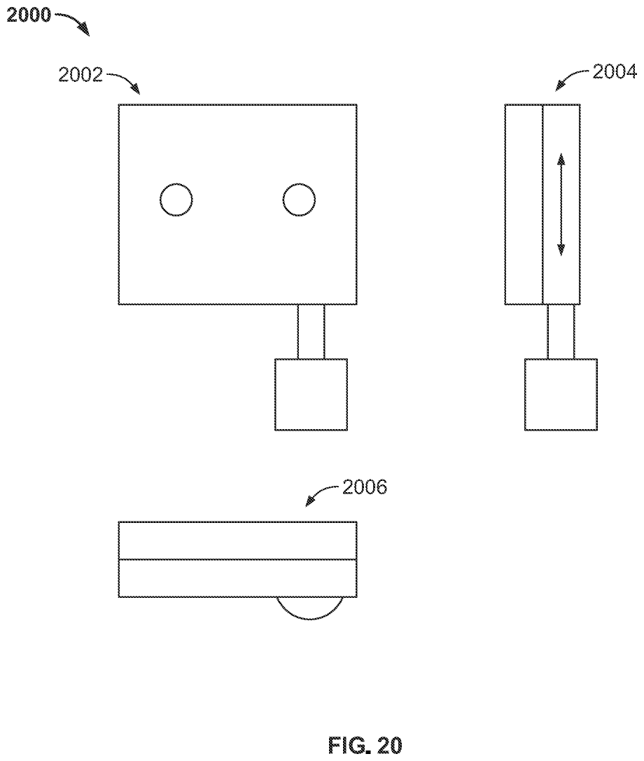

FIG. 20 illustrates an example of a micrometer positioner 2000 that can be used in assembly 1900. FIG. 20 includes side view 2002, front view 2004, and top view 2006 of micrometer positioner 2000.

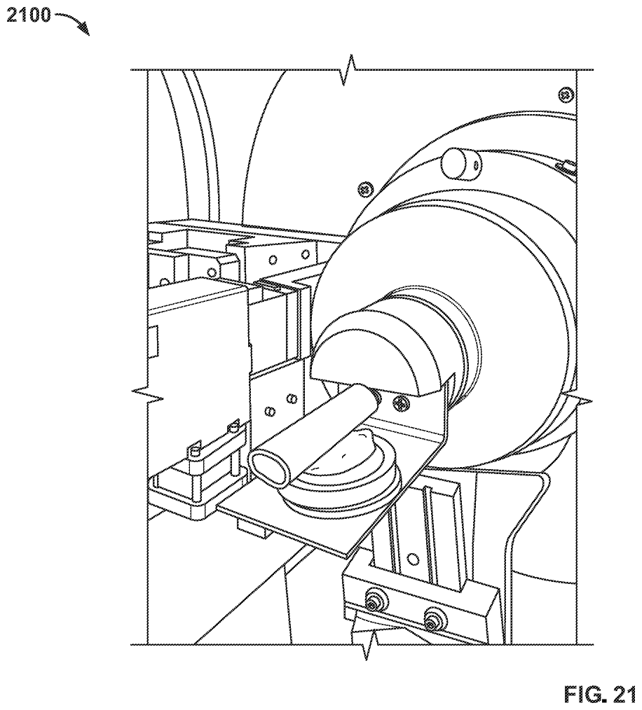

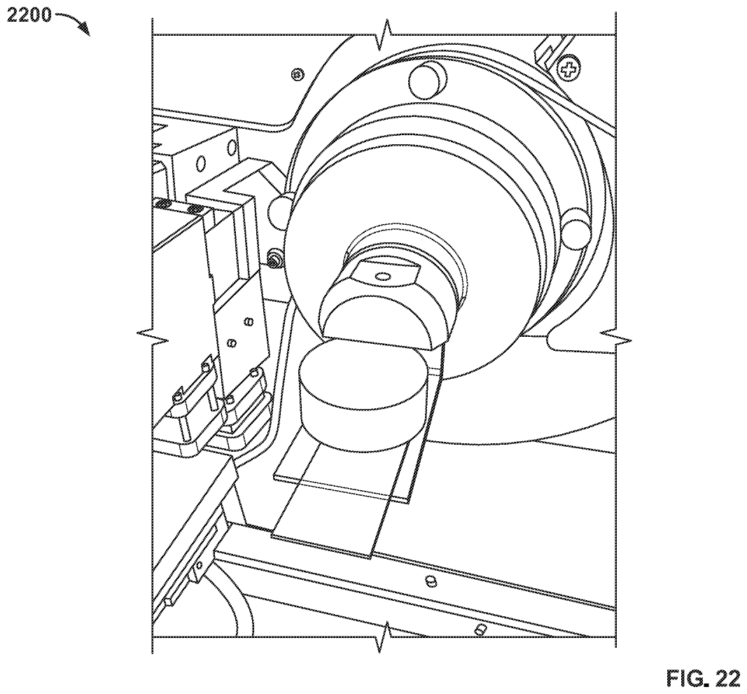

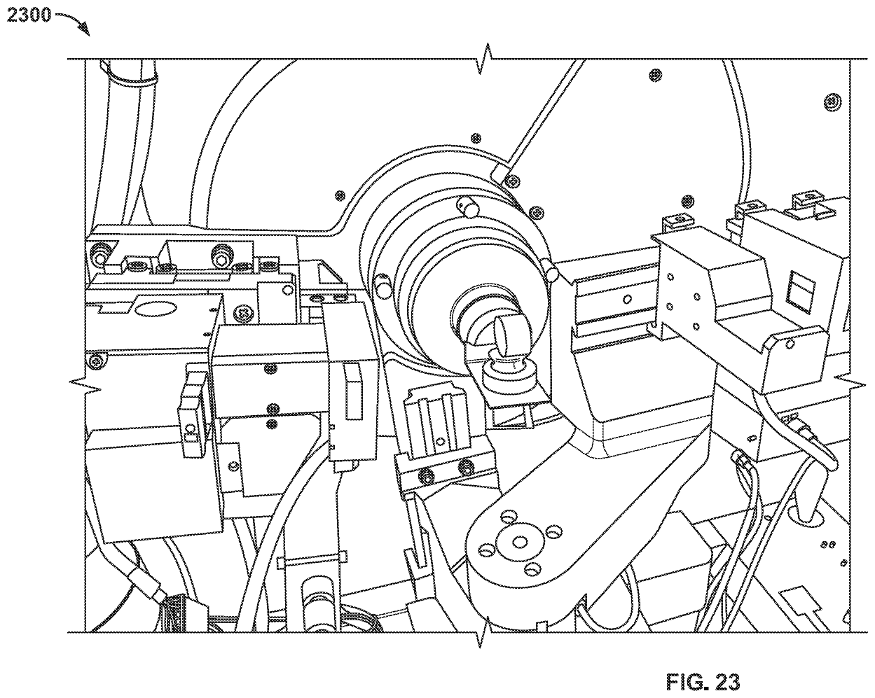

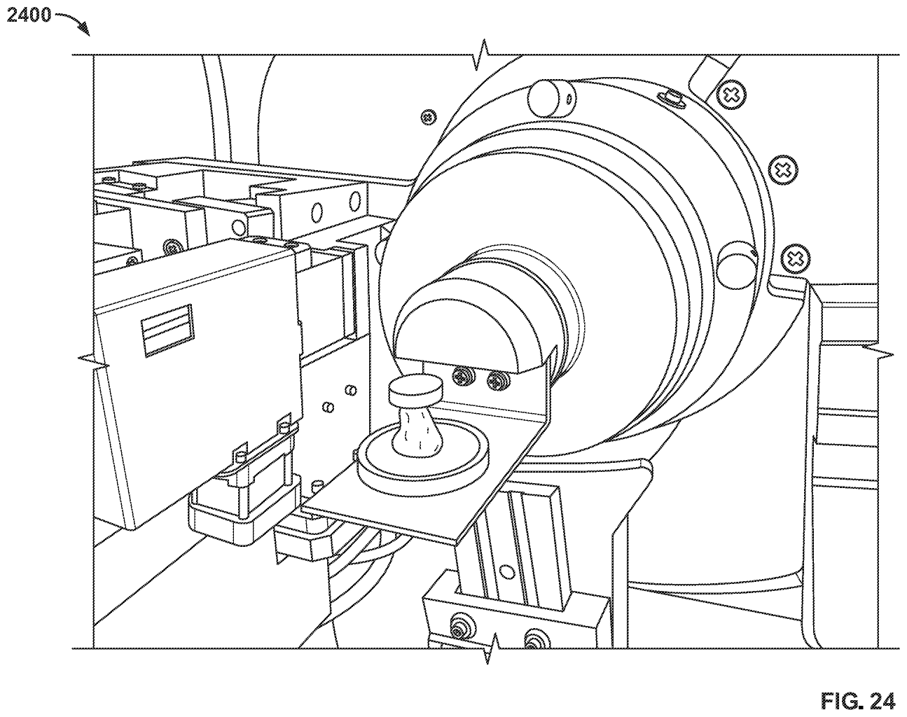

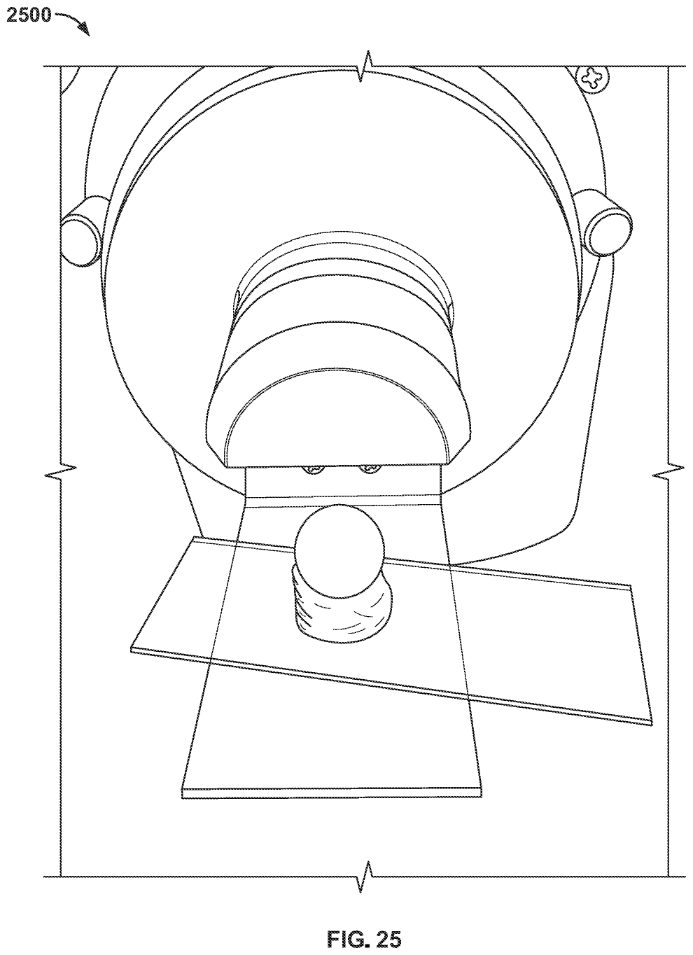

FIG. 21 illustrates an example prototype 2100 of using a specimen holder to measure the exterior surface of a component for fuel cell. FIG. 22 illustrates an example prototype 2200 of using a specimen holder to measure the surface of a treated calcite disk. FIG. 23 illustrates an example prototype 2300 of using a specimen holder to measure the internal coating on a pipe. FIG. 24 illustrates an example prototype 2400 of using a specimen holder to measure the thermogravimetric analysis residue of a reinforced rubber mounted on the stub of an Environmental Scanning Electron Microscope (ESEM). FIG. 25 illustrates an example prototype 2500 of using a specimen holder to determine the composition of an aluminum oxide catalyst support (Claus catalyst).

Certain aspects of the subject matter described here can be implemented as a specimen holder. The specimen holder includes an angle plate. The angle plate includes a first side and a second side. The first side and the second side are configured to join each other at an angle. The first side is configured to couple to a flange of the X-ray diffractometer, where the X-ray diffractometer includes a goniometer. The second side is configured to position a specimen in a measurement position for the X-ray diffractometer, where a rotation axis of the goniometer passes through a surface of the specimen.

An aspect taken alone or combinable with any other aspect includes the following features. The first side has multiple first holes, and the multiple first holes are configured to couple the first side to the flange of the X-ray diffractometer using multiple first screws.

An aspect taken alone or combinable with any other aspect includes the following features. The first side is configured to couple to the flange of the X-ray diffractometer through a plate, and the plate has multiple second holes configured to couple the first side to the flange of the X-ray diffractometer through one or more of the multiple second holes and using the multiple first screws.

An aspect taken alone or combinable with any other aspect includes the following features. The second side has multiple third holes, and the multiple third holes are configured to couple to the second side.

An aspect taken alone or combinable with any other aspect includes the following features. The multiple third holes are threaded holes.

An aspect taken alone or combinable with any other aspect includes the following features. The second side of the specimen holder is configured to couple to a specimen mount, the second side of the specimen holder comprises a folk with two prongs, and the two prongs of the folks are configured to position the specimen mount.

An aspect taken alone or combinable with any other aspect includes the following features. The two prongs of the folk form a tapering angle.

An aspect taken alone or combinable with any other aspect includes the following features. A distance between the second side of the specimen holder and a center of the goniometer is larger than a height of the specimen.

An aspect taken alone or combinable with any other aspect includes the following features. The second side of the specimen holder is configured to couple to a stage through a threaded hole on the second side, and the stage is configured to position the specimen and to change a height of the specimen relative to the second side through a rotation of the stage.

An aspect taken alone or combinable with any other aspect includes the following features. The first side of the specimen holder is configured to couple to a lead screw, and the lead screw is positioned through a threaded hole on the specimen holder and configured to change a height of the specimen holder through a rotation of the lead screw.

An aspect taken alone or combinable with any other aspect includes the following features. The specimen holder is configured to couple to a micrometer positioner, and the micrometer positioner is configured to change a height of the specimen holder.

An aspect taken alone or combinable with any other aspect includes the following features. The micrometer positioner comprises a motor.

An aspect taken alone or combinable with any other aspect includes the following features. The angle is 90 degrees.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

What is claimed is:

1. A specimen holder for an X-ray diffractometer, comprising:
an angle plate, wherein:
the angle plate comprises a first side and a second side;
the first side and the second side are configured to join each other at an angle;
the first side is configured to couple to a flange of the X-ray diffractometer, wherein the X-ray diffractometer comprises a goniometer; and
the second side is configured to position a specimen in a measurement position for the X-ray diffractometer, wherein a rotation axis of the goniometer passes through a surface of the specimen.

2. The specimen holder according to claim 1, wherein the first side has a first plurality of holes, and the first plurality of holes are configured to couple the first side to the flange of the X-ray diffractometer using a first plurality of screws.

3. The specimen holder according to claim 2, wherein the first side is configured to couple to the flange of the X-ray diffractometer through a plate, and the plate has a second plurality of holes configured to couple the first side to the flange of the X-ray diffractometer through one or more of the second plurality of holes and using the first plurality of screws.

4. The specimen holder according to claim 1, wherein the second side has a third plurality of holes, and wherein the third plurality of holes are configured to couple to the second side.

5. The specimen holder according to claim 4, wherein the third plurality of holes are threaded holes.

6. The specimen holder according to claim 1, wherein the second side of the specimen holder is configured to couple to a specimen mount, the second side of the specimen holder comprises a folk with two prongs, and the two prongs of the folks are configured to position the specimen mount.

7. The specimen holder according to claim 6, wherein the two prongs of the folk form a tapering angle.

8. The specimen holder according to claim 1, wherein a distance between the second side of the specimen holder and a center of the goniometer is larger than a height of the specimen.

9. The specimen holder according to claim 1, wherein the second side of the specimen holder is configured to couple to a stage through a threaded hole on the second side, and the stage is configured to position the specimen and to change a height of the specimen relative to the second side through a rotation of the stage.

10. The specimen holder according to claim 1, wherein the first side of the specimen holder is configured to couple to a lead screw, and the lead screw is positioned through a threaded hole on the specimen holder and configured to change a height of the specimen holder through a rotation of the lead screw.

11. The specimen holder according to claim 1, wherein the specimen holder is configured to couple to a micrometer positioner, and the micrometer positioner is configured to change a height of the specimen holder.

12. The specimen holder according to claim 11, wherein the micrometer positioner comprises a motor.

13. The specimen holder according to claim 1, wherein the angle is 90 degrees.
